(19) United States
(12) Patent Application Publication
(10) Pub. No.: US 2023/0270229 A1
(43) Pub. Date: Aug. 31, 2023

(54) MANICURE LAMP

(71) Applicant: GUANGZHOU BENYUAN INFORMATION TECHNOLOGY CO., LTD., Guangzhou (CN)

(72) Inventor: Yi DENG, Guangzhou (CN)

(73) Assignee: GUANGZHOU BENYUAN INFORMATION TECHNOLOGY CO., LTD., Guangzhou, GD (CN)

(21) Appl. No.: 18/181,570

(22) Filed: Mar. 10, 2023

Related U.S. Application Data
(63) Continuation of application No. PCT/CN2023/072983, filed on Jan. 18, 2023.

(30) Foreign Application Priority Data
Feb. 25, 2022 (CN) 202210179708.2

(51) Int. Cl. A45D 29/00

(52) U.S. Cl. CPC A45D 29/00

(57) ABSTRACT

A hardware structure of a manicure lamp includes a base for supporting fingers with nail tips, the area where the fingers are placed being named as a baking area, and a baking lamp for drying glue between fingers and nail tips in the baking area. A capacitive sensing device is provided inside the base for sensing whether fingers enter the baking area. A controller is electrically connected to the capacitive sensing device and the baking lamp. When the human hand reaches into the baking area of the manicure lamp, the capacitive sensing device will generate an electrical signal and send the electrical signal to the controller which can control the baking lamp to light up to bake glue when the human hand enters the baking area, or control the baking lamp to go out when the human hand leaves the baking area, which is convenient to use.

### FIELD

The present invention relates to the technical field of nail products, and more particularly, to a manicure lamp.

### BACKGROUND

During the manicure process, people usually use one hand to apply glue on the nails of the other hand and then attach the nail tips to the nails, and then use a manicure lamp to dry the glue on the nails, so that the nail tips can be firmly adhered to the nails. A conventional manicure lamp is provided with a baking lamp and a baking area, and is also provided with a switch to control the lighting of the baking lamp, and the switch is normally off to keep the baking lamp off. When baking glue, the user puts his/her hand into the baking area, and then needs to turn on the switch to make the baking lamp light up for glue baking. After baking glue, the user needs to turn off the switch again to make the baking lamp go out before leaving. For this kind of manicure lamps, the user needs to manually operate the switch to turn on and off the baking lamp, and thus it is quite inconvenient for the user to manually switch the lamp every time he/she bakes glue.

### SUMMARY

The technical problem to be solved by the present invention is to provide a hardware structure of a manicure lamp, wherein a controller is set up on the basis of the hardware structure, and the capacitive sensing device senses whether the fingers enter the baking area, and the controller controls the lighting of the baking lamp accordingly, which is convenient to use.

In one aspect, the present invention provides a hardware structure of a manicure lamp, which comprises a base for supporting fingers with nail tips attached thereon, an area where the fingers are disposed named as a baking area; a baking lamp configured to dry glue between the fingers and the nail tips located in the baking area; a capacitive sensing device being provided inside the base for sensing whether fingers enter the baking area; and a controller electrically connected to the capacitive sensing device and the baking lamp.

Preferably, the capacitive sensing device comprises a conductor and a circuit board, the circuit board is electrically connected to the conductor, and the controller is electrically connected to the circuit board.

Preferably, a conductive spring is connected between the conductor and the circuit board, and the circuit board is connected to the conductor through the conductive spring.

Preferably, the conductor is attached to an inner top wall of the base.

Preferably, the circuit board is spaced from the inner top wall of the base.

Preferably, the conductor is a metal sheet.

Preferably, the metal sheet is a tinfoil, and the inner top wall of the base has a non-planar area, and the tinfoil is secured to the non-planar area.

Preferably, a first side of the baking area is open for the fingers to be attached to reach into, and a second side of the baking area is open for the fingers grabbing nail tips to reach into and attach nail tips to the fingers to be attached; and the base has a convex part for supporting the fingers to be attached.

Preferably, the hardware structure of a manicure lamp further comprises a stand provided on the base; and the baking lamp is connected to the base through the support.

Preferably, the first side and the second side are not adjacent, a third side of the baking area is located between the first side and the second side, and the third side is open for the user to observe the baking area.

Preferably, the hardware structure of a manicure lamp further comprises a stand provided on the base; and the baking lamp is connected to the base through the support.

Preferably, the stand is located on a fourth side of the baking area, and the fourth side and the third side are opposite to each other.

Preferably, the first side and the second side are opposite to each other.

Preferably, the top of the base is arched, and the arched top serves as the convex part.

Preferably, the top of the base is in the shape of a hemisphere arched upwards, and the top of the hemisphere serves as the convex part.

A controller is provided on the basis of the hardware structure, and when the human hand reaches into the baking area of the manicure lamp, the capacitive sensing device will generate a capacitive induction, and then the capacitive sensing device will send an electrical signal to the controller, and finally, the controller can control the baking lamp to light up to bake glue when the human hand enters the baking area, or control the baking lamp to go out when the human hand leaves the baking area, which is convenient to use.

### BRIEF DESCRIPTION OF THE DRAWINGS

FIG. 1 an axonometric view of the manicure lamp;

FIG. 2 is a sectional view of the manicure lamp cut along line C-C in FIG. 1, in which the conductive spring and the circuit board are not cut;

FIG. 3 is an exploded view of the base; and

FIG. 4 illustrates a block diagram of a controller, circuit board and baking lamp.

### DESCRIPTION OF THE EMBODIMENTS

The present invention will be described in further detail below in conjunction with specific embodiments.

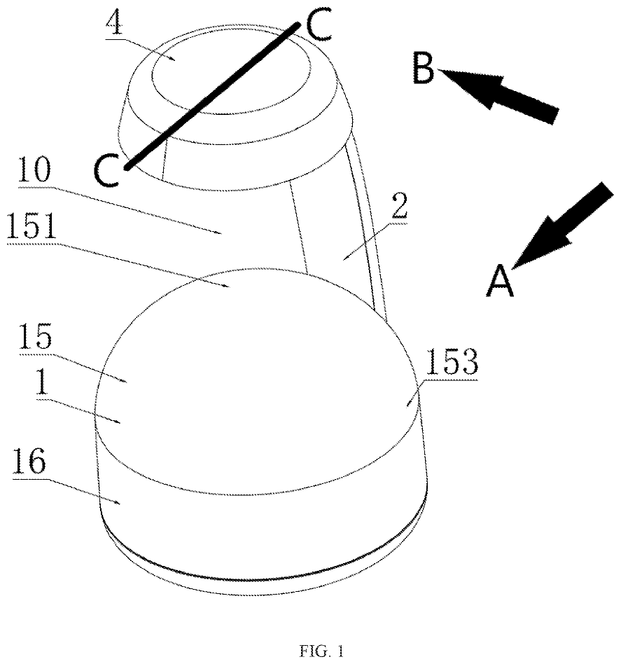

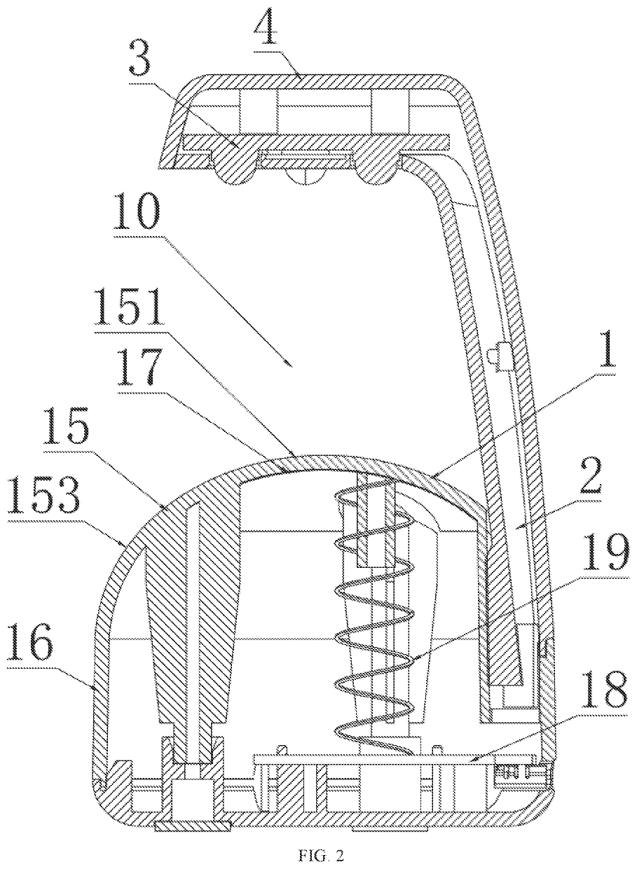

As shown in FIG. 1, a manicure lamp according to an embodiment of the present invention comprises a base 1. A baking area 10 for fingers to be placed is arranged above the base 1. By taking the direction indicated by the arrow B as the leftward, the left and right sides of the baking area 10 are open for the user's left and right hands to reach into, respectively. After the user put both hands into the baking area 10, he/she grabs the nail tip with the fingers of his/her right hand and attach it on the nail of the left hand. By taking the direction indicated by the arrow A as the frontward, the front side of the baking area 10 is open for the user to observe the situation in the baking area 10 during the nail tip attaching process. As shown in FIG. 1 and FIG. 2, a stand 2 is installed on the back side of the base 1, and a lamp holder 4 located above the base 1 is arranged at the top of the stand 2, a baking lamp 3 is installed on the lamp holder 4. The baking lamp 3 is configured to dry the glue between the nails of the left hand and the nail tips mounted on the nails of the left hand.

As shown in FIG. 1, the top 15 of the base 1 is an upwardly arched hemispherical shell, and the top of the shell acts as the convex part 151 of the base 1. When the user attaches the nail tip, the fingers of the left hand are placed on the convex part 151 of the base 1, and the fingers of the right hand grab the front end of the nail tip and place it on the peripheral side 153 of the base 1 and attach the rear end of the nail tip on the nail of the left hand, so that the nail tip fits the nail.

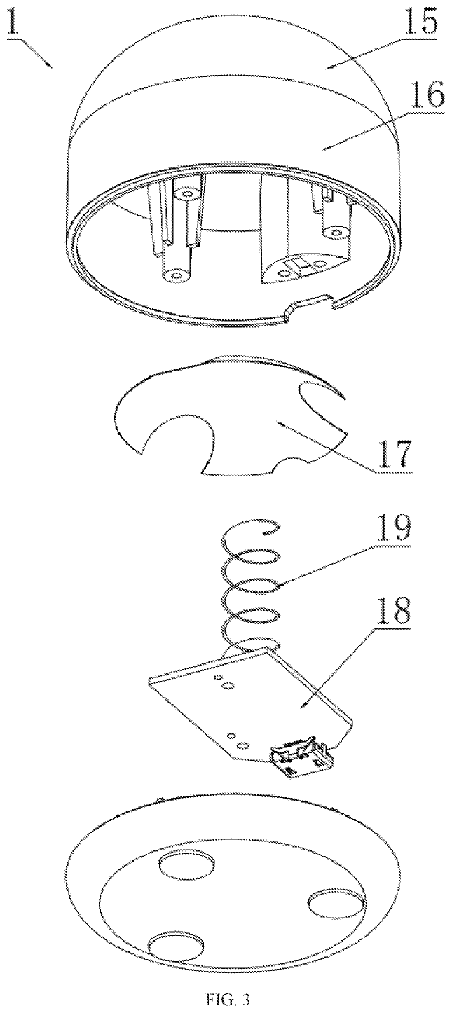

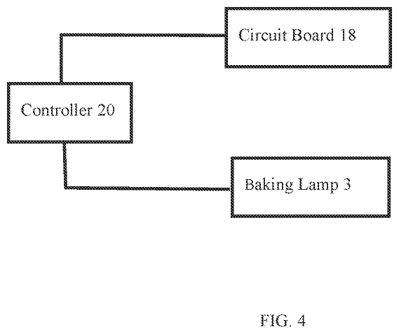

As shown in FIG. 2 and FIG. 3, a metal sheet 17 and a circuit board 18 are provided inside the base 1. The metal sheet 17 can be secured to the inner top wall of the base 1, the circuit board 18 is located at the bottom 16 of the base 1, a conductive spring 19 is sandwiched between the metal sheet 17 and the circuit board 18, the conductive spring 19 electrically connects the circuit board 18 and the metal sheet 17 together, and the metal sheet 17, the circuit board 18 and the conductive spring 19 cooperatively constitute a capacitive sensing device. A controller 20 is provided inside the base 1 as shown in FIG. 4, and the controller 20 is electrically connected to the circuit board 18 and the baking lamp 3. In a normal state, the controller controls the baking lamp in the off state. When a human hand reaches into the baking area 10, a capacitive induction is generated with the metal sheet 17 (i.e., a capacitive is generated between the human hand and the metal sheet), and consequently the circuit board 18 sends an electric signal to the controller 20. controller 20 controls the baking lamp 3 to light up for 60 seconds. Within the 60 seconds, if the human hand leaves from the baking area 10, the controller 20 will control the baking lamp 3 to go out to save electric energy when the human hand leaves; if the human hand does not leave the baking area 10 within 60 seconds, the controller 20 will control the baking lamp 3 to go out upon the expiration of 60 seconds to prevent overbaking.

When the user grabs the nail tips with the fingers of the right hand and attaches them on the nails of the left hand, the fingers of the left hand are named as the fingers to be attached, and the fingers of the right hand are named as the fingers grabbing the nail tip. In other embodiments, it may be that the manicurist grabs the nail tip and attaches it on the customer's nails, then the customer's fingers are named as the fingers to be attached, and the fingers of the manicurist are named as the fingers grabbing the nail tip.

As shown in FIG. 1 and FIG. 2, in this embodiment, the baking lamp shines on the top of the base 1, the user's fingers are placed on the top of the base 1, the top of the base 1 forms the baking area, and the top 15 of the base 1 is located on the upper surface of the base 1. In other embodiments, the baking lamp can be changed to shine on the front of the base 1, so that the front of the base 1 forms the baking area, the user's fingers are placed in front of the base 1, and the top 15 of the base 1 is located on the front surface of the base 1.

In this embodiment, the metal sheet 17 is hard, and it is not easy for the metal sheet 17 to fit the non-planar shape (such as an arc surface) of the inner top wall of the base, and there will be a gap between the metal sheet and the inner top wall of the base, which will affect the capacitive sensing effect. In other embodiments, the metal sheet can be changed to a tinfoil which is soft and can better fit the non-planar area of the inner top wall of the base.

Described above are merely specific embodiments of the invention, but the protection scope of the invention is not limited thereto. Any variations or substitutions readily conceivable to any person familiar with and skilled in the art should be included within the protection scope of the present invention. The protection scope of the invention shall be subject to the protection scope defined by the claims.

What is claimed is:

1. A manicure lamp, comprising:
a base for supporting fingers with nail tips attached thereon, an area where the fingers are disposed named as a baking area;
a baking lamp configured to dry glue between the fingers and the nail tips located in the baking area;
a capacitive sensing device being provided inside the base for sensing whether fingers enter the baking area; and
a controller electrically connected to the capacitive sensing device and the baking lamp.

2. The manicure lamp according to claim 1, wherein the capacitive sensing device comprises a conductor and a circuit board, the circuit board is electrically connected to the conductor, and the controller is electrically connected to the circuit board.

3. The manicure lamp according to claim 2, wherein a conductive spring is connected between the conductor and the circuit board, and the circuit board is connected to the conductor through the conductive spring.

4. The manicure lamp according to claim 2, wherein the conductor is attached to an inner top wall of the base.

5. The manicure lamp according to claim 4, wherein the circuit board is spaced from the inner top wall of the base.

6. The manicure lamp according to claim 2, wherein the conductor is a metal sheet.

7. The manicure lamp according to claim 6, wherein the metal sheet is a tinfoil, and the inner top wall of the base has a non-planar area, and the tinfoil is secured to the non-planar area.

8. The manicure lamp according to claim 1, wherein a first side of the baking area is open for the fingers to be attached to reach into, and a second side of the baking area is open for the fingers grabbing nail tips to reach into and attach nail tips to the fingers to be attached; and
the base has a convex part for supporting the fingers to be attached.

9. The manicure lamp according to claim 8, further comprising a stand provided on the base;
and the baking lamp is connected to the base through the support.

10. The manicure lamp according to claim 8, wherein the first side and the second side are not adjacent, a third side of the baking area is located between the first side and the second side, and the third side is open for the user to observe the baking area.

11. The manicure lamp according to claim 10, further comprising a stand provided on the base;
and the baking lamp is connected to the base through the support.

12. The manicure lamp according to claim 11, wherein the stand is located on a fourth side of the baking area, and the fourth side and the third side are opposite to each other.

13. The manicure lamp according to claim 8, wherein the first side and the second side are opposite to each other.

14. The manicure lamp according to claim 8, wherein the top of the base is arched, and the arched top serves as the convex part.

15. The manicure lamp according to claim 14, wherein the top of the base is in the shape of a hemisphere arched upwards, and the top of the hemisphere serves as the convex part.
